(19) United States
(12) Patent Application Publication
(10) Pub. No.: US 2007/0294546 A1
(43) Pub. Date: Dec. 20, 2007

(54) HOST DEVICE SHUTDOWN SYSTEM

(75) Inventor: Michael M. Lee, San Jose, CA (US)

Correspondence Address: BEYER WEAVER LLP, P.O. BOX 70250, OAKLAND, CA, 94612-0250, US

(73) Assignee: Apple Computer, Inc.

(21) Appl. No.: 11/425,099

(22) Filed: Jun. 19, 2006

(51) Int. Cl. G06F 1/00

(52) U.S. Cl. 713/300

(57) ABSTRACT

A host device, such as a personal computer, is shut down only after a client device (such as a portable personal media player) having a client device shutdown condition (such as a media player battery is fully charged) is satisfied. Such conditions include recharging a media player battery and completing transferring data files between host device and media player.

### FIELD OF INVENTION

This invention relates generally to host/client device systems where the client device includes personal, portable electronic devices such as media players, radios, cell phones and the like.

### DESCRIPTION OF RELATED ART

Recent developments in consumer electronics have included the introduction devices that can act as either a peripheral device when connected to a host system (such as a personal computer) or, when unconnected to the host system, as a self-contained portable device. Such devices include portable personal communication devices such as media players (such as MP3 players, minidisk players), cell phones, personal digital assistants (PDAs) and the like. When operating in a portable mode, these devices rely upon an internal power supply that utilizes a rechargeable power storage unit (such as a battery) to provide the requisite charge used to power the device. On the other hand, when the device is connected to the host system, power is provided by a power supply incorporated in the host system using a connector that includes a power supply line and in some cases a data line (such as a USB type cable) as well as any power supply internal to the peripheral device (such as a battery).

During operation, when the client device is connected to the host device, a client device internal power supply is used to power the client device as well the power supply incorporated into the host device that can used to both power the client device and recharge the rechargeable power storage unit (when needed). Unfortunately, however, in order to recharge the rechargeable power storage unit, the host system must be active for at least a period of time long enough to fully recharge the rechargeable power storage unit, which, depending on the circumstances, can take a number of hours. For example, if the host system is a personal computer (such as an iMac™) and the portable device is a portable media player such as an iPod™ both manufactured by Apple Computer Inc. of Cupertino Calif., the iMac™ must be fully operational until the battery in the iPod™ is fully charged. In this way, a user must be cognizant when the battery is fully charged in order to shutdown the iMac™ and if this is not feasible or desirable, then the iMac™ must be left on until such time as the user returns to shut down the system.

Therefore, there is a need for improved approaches to shutting down a host computer.

### SUMMARY OF THE INVENTION

A method, computer program product, and consumer product for shutting down a host device connected to a client device only when a client device shutdown condition is satisfied. In one embodiment, the host device is a personal computer and the client device is a portable personal media player having a rechargeable battery unit. A user can select that the personal computer can only be shutdown if the media player rechargeable battery unit is fully recharged.

In another embodiment, computer program product executable by a processor unit for shutting down a host device connected to a client device is disclosed that includes computer code for shutting down the host device only when a client device shutdown condition is satisfied and computer readable medium for storing the computer code.

In yet another embodiment, A consumer electronic product having a host portion and a client portion is disclosed wherein in order to shut down the host portion, a client portion shutdown condition must be satisfied.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention will be better understood by reference to the following description taken in conjunction with the accompanying drawings.

FIG. 1 shows a system in accordance with an embodiment of the invention.

FIG. 2 shows a portable media player according to one embodiment of the invention.

FIG. 3 shows schematic representation of a consumer electronic product in accordance with an embodiment of the invention.

FIG. 4 shows a flowchart detailing a process in accordance with an embodiment of the invention.

### DETAILED DESCRIPTION OF SELECTED EMBODIMENTS

Reference will now be made in detail to a particular embodiment of the invention, an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

The invention provides for shutting down a host system based upon the satisfaction of a condition provided by a client device. In the example described below, a user selects an option that provides for automatically shutting down the host system only when the battery of a peripheral device attached thereto is fully recharged. In this case, when the client device determines that the battery is fully charged, then the client device generates and forwards to the personal computer, a signal that indicates that the battery is fully charged. The personal computer reacts to the receipt of the signal by completing the personal computer shutdown procedure without additional user inputs. In the way, the user can elect to shut down the personal computer and walk away confident that the computer will be operational only until the battery in the client device is fully charged and no longer.

The invention will now be described in terms of a consumer electronic product that includes a portable media player capable of storing a number of multimedia digital files connected to a host device such as a personal computer, media delivery unit, etc arranged to provide multimedia digital files to the portable media player when requested. In the case of the media player being a pocket sized portable player (such as the IPOD™ player manufactured by the Apple Computer Inc. of Cupertino, Calif.), the multimedia data files can include MP3 files as well as any other appropriately formatted data files.

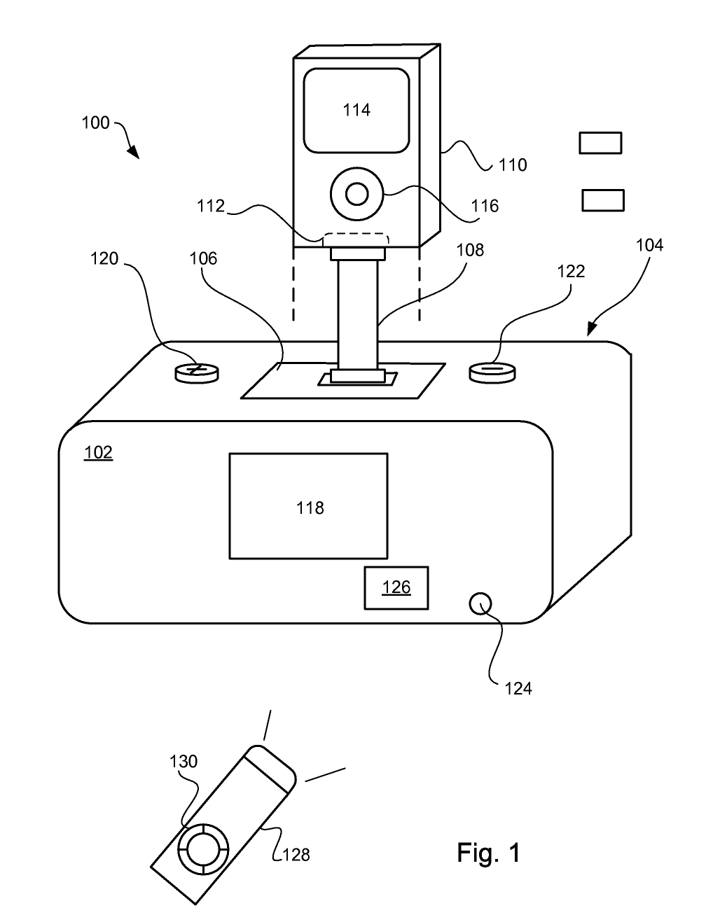

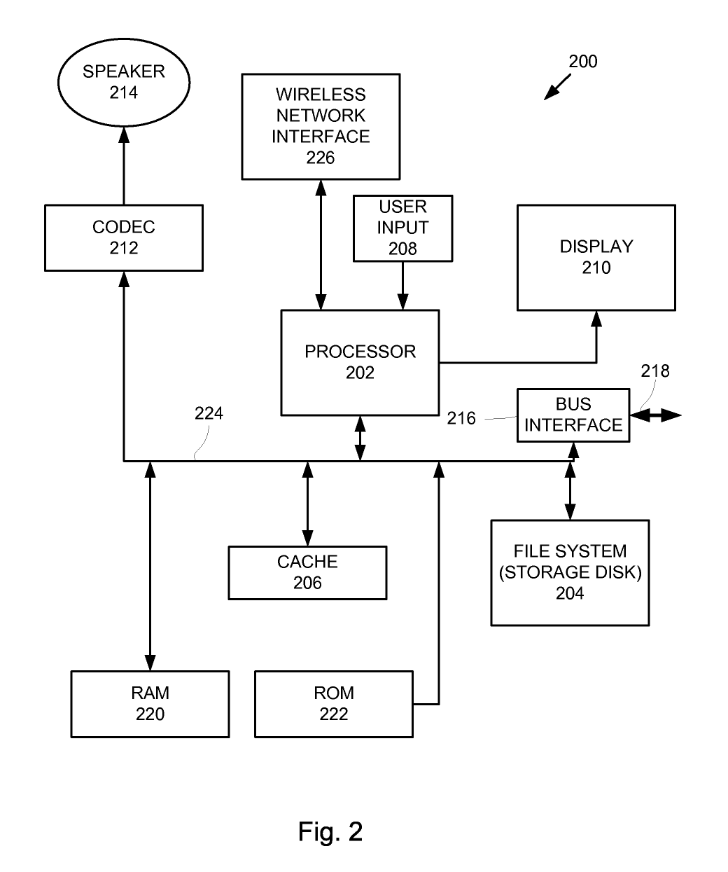

FIG. 1 is a diagram of a system 100 according to one embodiment of the invention. The system 100 includes a host device 102. The host device 102 includes a housing 104 that supports or contains various components of the host device 102. The housing 104 includes an interface 106 arranged to receive a connector 108. Beyond the host device 102, the system 100 also includes a client device that in the described embodiment takes the form of a battery powered portable media player 110 110. The portable media player 110 is, more generally, a portable computing device, such as the mobile computing device 200 illustrated in FIG. 2. Although the portable media player 110 is fully operational apart from the host device 102, the portable media player 110 can be connected to the host device 102. In particular, the portable media player 110 includes an interface 112. In the described embodiment, the connector 108 physically and electrically connects with the interface 112 of the portable media player 110, thereby connecting the portable media player 110 to the host device 102.

The host device 102 includes a user interface 118. The housing 104 also includes volume control devices 120 and 122. In one embodiment, the volume control devices 120 and 122 are buttons. Still further, the housing 104 can include an indicator light 124 that provide visual feedback to the user regarding the operation or condition of the host device 102. The housing 104 can also include a receiver window 126 that can be used by a receiver internal to the housing 104 when picking-up wireless transmissions from a remote controller 128 having a plurality of user input controls 130. It should be noted that the remote controller 128 could transmit any of a number of signals such as infrared, radio frequency (RF), audio signals, and the like. Through use of the user input controls 130 on the remote controller 128, the user is able to indirectly interact with the portable media player 110 or directly interact with the host device 102. For example, the user of the remote controller 128 can interact with the user input controls 130 to select a media item to be played on the portable media player 110 with its audio output being provided by the speakers 118 of the host device 102. The remote controller 128 can also be used to alter the volume of the audio output from the host device 102.

FIG. 2 shows a portable media player 200 according to one embodiment of the invention. The media player 200 is, for example, suitable for use as the battery powered portable media player 110 shown in FIG. 1. The media player 200 includes a processor 202 that pertains to a microprocessor or controller for controlling the overall operation of the media player 200. The media player 200 stores media data pertaining to media assets in a file system 204 and a cache 206. The file system 204 is, typically, a storage disk or a plurality of disks. The file system 204 typically provides high capacity storage capability for the media player 200. However, since the access time to the file system 204 is relatively slow, the media player 200 can also include a cache 206. The cache 206 is, for example, Random-Access Memory (RAM) provided by semiconductor memory. The relative access time to the cache 206 is substantially shorter than for the file system 204. However, the cache 206 does not have the large storage capacity of the file system 204. Further, the file system 204, when active, consumes more power than does the cache 206. The power consumption is particularly important when the media player 200 is a portable media player that is powered by a battery (not shown). The media player 200 also includes a RAM 220 and a Read-Only Memory (ROM) 222. The ROM 222 can store programs, utilities or processes to be executed in a non-volatile manner. The RAM 220 provides volatile data storage, such as for the cache 206.

The media player 200 also includes a user input device 208 that allows a user of the media player 200 to interact with the media player 200. For example, the user input device 208 can take a variety of forms, such as a button, keypad, dial, etc. Still further, the media player 200 includes a display 210 (screen display) that can be controlled by the processor 202 to display information to the user. A data bus 224 can facilitate data transfer between at least the file system 204, the cache 206, and the processor 202. The media player 200 also includes a bus interface 216 that couples to a data link 218. The data link 218 allows the media player 200 to couple to a host computer over a wired connection.

In one embodiment, the media player 200 serves to store a plurality of media assets (e.g., songs) in the file system 204. When a user desires to have the media player 200 play a particular media item, a list of available media assets is displayed on the display 210. Then, using the user input device 208, a user can select one of the available media assets. The processor 202, upon receiving a selection of a particular media item, supplies the media data (e.g., audio file) for the particular media item to a coder/decoder (CODEC) 212. The CODEC 212 then produces analog output signals for a speaker 214. The speaker 214 can be a speaker internal to the media player 200 or external to the media player 200. For example, headphones or earphones that connect to the media player 200 would be considered an external speaker.

The media player 200 also includes a wireless network interface 226 arranged to wirelessly transmit any selected data from the media player 200 to any appropriately configured receiver unit (e.g., the wireless network interface 114) over a wireless network. In the embodiment shown in FIG. 1, the wireless network interface 226 that takes the form of, for example, a “WiFi” interface according to the IEEE 802.11b or 802.11g standards. Other wireless network standards could also be used, either in alternative to the identified standards or in addition to the identified standards. Such other network standards could include the IEEE 802.11a standard or the Bluetooth standard.

In one embodiment, the media player 200 is a portable computing device dedicated to processing media such as audio. For example, the media player 200 can be a media player (e.g., MP3 player), a game player, a remote controller, a portable communication device, and the like. These devices are generally battery-operated and highly portable so as to allow a user to listen to music, play games or video, record video or take pictures, communicate with others, and/or control other devices. In one implementation, the media player 200 is a handheld device that is sized for placement into a pocket or hand of the user. By being handheld, the media player 200 is relatively small and easily handled and utilized by its user. By being pocket sized, the user does not have to directly carry the device and therefore the device can be taken almost anywhere the user travels (e.g., the user is not limited by carrying a large, bulky and often heavy device, as in a portable computer). Furthermore, the user's hands may operate the device, no reference surface such as a desktop is needed.

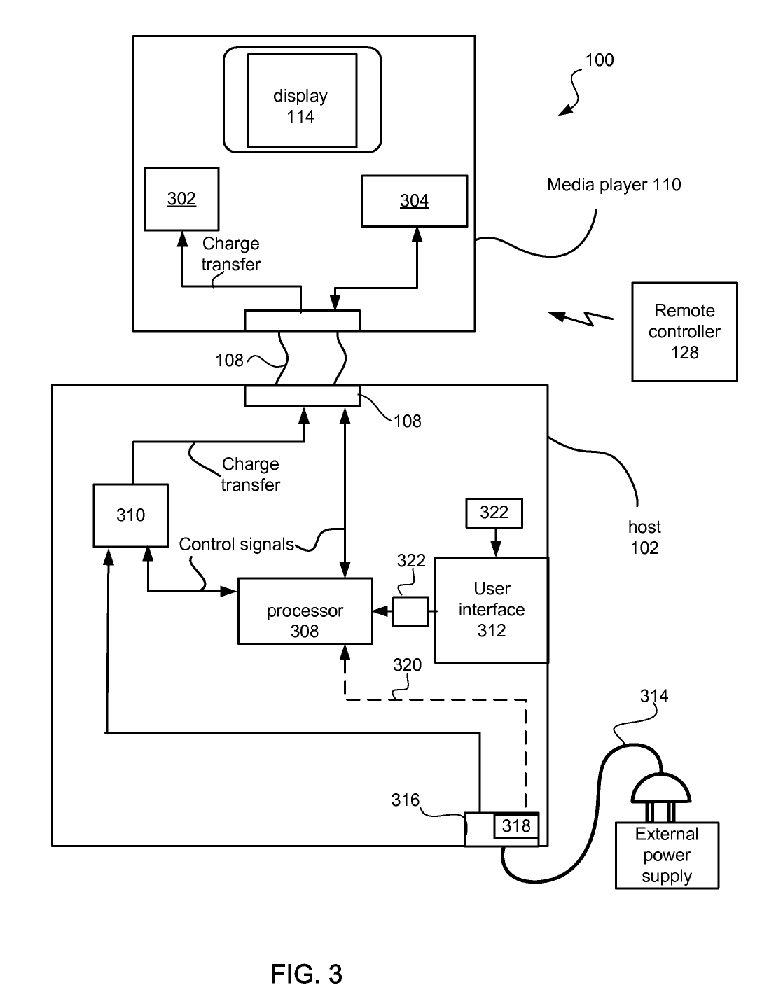

FIG. 3 shows a detailed implementation of the system 100 shown in FIG. 1 that includes the portable media player 110 and the host device 102. In the described embodiment the media player 110 is connected to the host device 102 when the connector 108 physically and electrically connects with the connector 112 thereby creating a data/power pathway between the portable media player 110 and the host device 102. The media player 110 includes a media player internal power supply 302 arranged to store charge used to power to media player 110 before (including booting up) and during playback of selected digital media files. The media player 110 also includes a memory unit 304 suitably arranged to store media files.

The host device 102 includes a processor unit 308 arranged to process executable instructions and provide a number of control signals used to control, in part, an internal power supply 310 and a user interface 312 arranged to receive user commands. When the media player 110 and the host device 102 are connected by way of the connector 108, the data/power path between the media player 110 and the host device 102 is unidirectional with regards to transferring charge from the internal power supply 310 to the media player internal power supply 302 but bidirectional with regards to transferring data between the media player 110 and the host device 102. It should be noted that the internal power supplies 310 and 302 are contemplated to be any of a number and type of internal power supplies suitable for portable applications such as a battery (alkaline, nickel metal hydride, etc.) or a small fuel cell.

A detachable power cable 314 provides power to the internal power supply 310 from an external power supply when connected to a power port 316. In a particularly useful embodiment, the power port 316 includes a power cable sensor 318 that reacts to a power cable connect/disconnect event by sending a power cable status signal 320 to the processor unit 308 that signals in the case of a disconnect event that the system 300 is in a self powered mode (i.e., power is supplied only by the internal power supplies 310 and 302).

It should be noted that at any time the power cable 314 is connected to the external power supply, the processor 308 immediately signals the system 100 to enter an external power mode, or AC mode. In the external power mode, the charge provided by the external power supply by way of the cable 314 is used to not only operate the system 300, but to recharge (if necessary) the internal power supplies 302 and 310.

However, in those cases where a user wishes to shutdown the host device 102 while the power supply 302 is being recharged, a user will enter a shutdown command 322 at the user interface 312. The command 322 will in turn be received at the processor 308 that will respond by determining if the media player 110 is still connected by way of the cable 108. In those cases where the media player 110 is no longer connected, then the processor 308 will issue a host device shutdown command resulting in the shutting down of the host device 102 without further ado.

However, if the processor 308 determines that the media player 110 is still connected, then the processor 308 will further determine if there are any media player conditions that must be satisfied prior to the issuance of the host device shutdown command. Such conditions include, for example, completion of recharging of the media player internal power supply 302 by maintaining the transferring of charge from the internal power supply 310 to the media player internal power supply 302 and downloading data files (such as media files) between the media player 110 and the host device 102). Only when the media player shutdown condition (i.e., media player internal power supply 302 has been recharged or the file download is complete) has been satisfied will the processor 308 issue the host device shutdown command thereby causing the host device 102 to shutdown. In this way, a user can arrange for the host device 102 to shutdown confident that the media player internal power supply 302 will be recharged without further user intervention.

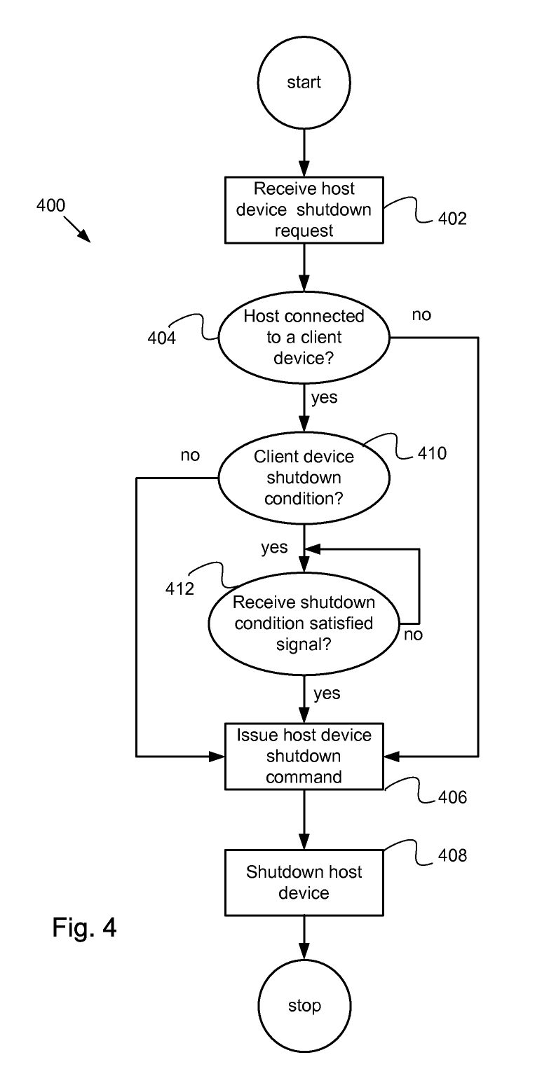

FIG. 4 shows a flowchart detailing a process 400 in accordance with an embodiment of the invention. The process 400 begins at 402 by receiving a host device shutdown request after which a determination is made if the host device is connected to a client device at 404. If the host device is not connected to a client device, then a host device shutdown command is issued at 406 resulting in the host device shutting down at 408. On the other hand, if host device is connected to a client device, then a determination is made at 410 whether or not the client device has an associated shutdown condition that must be satisfied prior to shutting down the host device. If there is no client device shutdown condition, then the shutdown command is issued at 406 and the host device is shut down at 408, otherwise, the host device waits to issue the host device shutdown command until such time as a client device condition satisfaction signal is received at 412. For example, if the client device shutdown condition is “fully charge a client device battery”, then the host device will suspend issuing the host device shutdown command until the client device battery is fully charged and the client device issues the appropriate “client device battery is fully charged” signal to the host device. Once the host device receives the appropriate client device condition satisfaction signal, then the host device issues the host device shutdown command at 406 and the host device shuts down at 410.

Although the media items of emphasis in several of the above embodiments where audio items (e.g., audio files or songs), the media items are not limited to audio items. For example, the media item can alternatively, pertain to recorded discussions and the like.

The invention is preferably implemented by software, but can also be implemented in hardware or a combination of hardware and software. The invention can also be embodied as computer readable code on a computer readable medium. The computer readable medium is any data storage device that can store data, which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

What is claimed is:

1. A method of shutting down a host device connected to a client device, comprising:
shutting down the host device only when a client device shutdown condition is satisfied.

2. A method for shutting down a host device as recited in claim 1, comprising;
receiving a host device shutdown request;
determining if the client device has a client device shutdown condition;
issuing a host device shutdown command only when the client device shutdown condition is satisfied.

3. A method as recited in claim 2 wherein the client device includes a rechargeable battery unit

4. A method as recited in claim 3, further comprising:
providing a charging current to the rechargeable battery unit by the host device.

5. A method as recited in claim 4, wherein the client device shutdown condition provides for fully recharging the rechargeable battery unit or completing a data file transfer between the client device and the host device.

6. A method as recited in claim 5, wherein only when the rechargeable battery unit is fully recharged, then
issuing a signal by the client device indicating that the rechargeable battery unit is fully recharged; and
receiving the signal by the host device indicating that the client device shutdown condition has been satisfied.

7. A method as recited in claim 6, wherein the signal issued by the client device is a wireless transmission.

8. A method as recited in claim 1, wherein the host device is a personal computer.

9. A method as recited in claim 1, wherein the client device is a portable personal media player unit.

10. Computer program product executable by a processor unit for shutting down a host device connected to a client device, comprising:
computer code for shutting down the host device only when a client device shutdown condition is satisfied; and
computer readable medium for storing the computer code.

11. Computer program product for shutting down a host device as recited in claim 1, comprising;
computer code for receiving a host device shutdown request;
computer code for determining if the client device has a client device shutdown condition;
computer code for issuing a host device shutdown command only when the client device shutdown condition is satisfied.

12. Computer program product as recited in claim 11 wherein the client device includes a rechargeable battery unit

13. Computer program product as recited in claim 12, further comprising:
computer code for providing a charging current to the rechargeable battery unit by the host device.

14. Computer program product as recited in claim 13, wherein the client device shutdown condition provides for fully recharging the rechargeable battery unit.

15. Computer program product as recited in claim 14, wherein only when the rechargeable battery unit is fully recharged, then
computer code for issuing a signal by the client device indicating that the rechargeable battery unit is fully recharged; and
computer code for receiving the signal by the host device indicating that the client device shutdown condition has been satisfied.

16. Computer program product as recited in claim 15, wherein the signal issued by the client device is a wireless transmission.

17. Computer program product as recited in claim 10, wherein the host device is a personal computer.

18. Computer program product as recited in claim 10, wherein the client device is a portable personal media player unit.

19. A consumer product, comprising:
a host portion; and
a client portion optionally connected to the host portion wherein in order to shut down the host portion, a client portion shutdown condition must be satisfied.

20. A consumer product as recited in claim 19, wherein the host portion includes a processor unit arranged to receive and execute instructions.

21. A consumer product as recited in claim 20, wherein when the host portion receives a host portion shutdown request, the processor determines if the client device has an associated client device shutdown condition.

22. A consumer product as recited in claim 21, wherein if the processor determines that the client portion does not have an associated client portion shutdown condition, then the processor issues a host portion shutdown command, otherwise the processor suspends issuing the host portion shutdown command.

23. A consumer product as recited in claim 22, wherein when the client portion shutdown condition has been satisfied, then the client portion notifies the host portion accordingly.

24. A consumer product as recited in claim 23, wherein when the host portion is notified that that client portion shutdown condition has been satisfied, then the processor issues the host portion shutdown command.

25. A consumer product as recited in claim 19, wherein the host portion is a personal computer and wherein the client portion is a portable personal media player having a rechargeable media player battery unit.

26. A consumer product as recited in claim 25, wherein a media player shutdown condition is satisfied when the rechargeable media player battery unit is fully recharged.

27. A consumer product as recited in claim 26, wherein the personal computer is shutdown only when the media player battery unit is fully recharged.
